(19) United States
(12) Patent Application Publication
(10) Pub. No.: US 2016/0191935 A1
(43) Pub. Date: Jun. 30, 2016

(54) METHOD AND SYSTEM WITH DATA REUSE IN INTER-FRAME LEVEL PARALLEL DECODING

(71) Applicant: MEDIATEK INC., Hsin-Chu (TW)

(72) Inventors: Ping Chao, Taipei City (TW); Chia-Yun Cheng, Hsinchu County (TW); Chih-Ming Wang, Hsinchu County (TW); Yung-Chang Chang, New Taipei City (TW)

(21) Appl. No.: 14/979,578

(22) Filed: Dec. 28, 2015

Related U.S. Application Data
(60) Provisional application No. 62/096,922, filed on Dec. 26, 2014.

(51) Int. Cl. H04N 19/423; G06F 5/06; H04N 19/44; G06F 12/08

(52) U.S. Cl. CPC H04N 19/423; G06F 12/0811; G06F 5/065; H04N 19/44; G06F 2205/067; G06F 2212/283

(57) ABSTRACT

A multi-core decoder system and an associated method use a decoding progress synchronizer to reduce bandwidth consumption for decoding a video bitstream is disclosed. In one embodiment of the present invention, the multi-core decoder system includes a shared reference data buffer coupled to the multiple decoder cores and an external memory. The shared reference data buffer stores reference data received from the external memory and provides the reference data the multiple decoder cores for decoding video data. The multi-core decoder system also includes one or more decoding progress synchronizers coupled to the multiple decoder cores to detect decoding-progress information associated with the multiple decoder cores or status information of the shared reference data buffer, and to control decoding progress for the multiple decoder cores.

### CROSS REFERENCE TO RELATED APPLICATIONS

The present invention claims priority to U.S. Provisional Patent Application, Ser. No. 62/096,922, filed on Dec. 26, 2014. The present invention is also related to U.S. patent application Ser. No. 14/259,144, filed on Apr. 22, 2014. The U.S. Provisional Patent Application and the U.S. Patent Application are hereby incorporated by reference in their entireties.

### BACKGROUND

The present invention relates to Inter-frame level parallel video decoding system. In particular, the present invention relates to data reuse for the system in order to reduce bandwidth consumption.

Compressed video has been widely used nowadays in various applications, such as video broadcasting, video streaming, and video storage. The video compression technologies used by newer video standards are becoming more sophisticated and require more processing power. On the other hand, the resolution of the underlying video is growing to match the resolution of high-resolution display devices and to meet the demand for higher quality. For example, compressed video in High-Definition (HD) is widely used today for television broadcasting and video streaming. Even UHD (Ultra High Definition) video is becoming a reality and various UHD-based products are available in the consumer market. The requirements of processing power for UHD contents increase rapidly with the spatial resolution. Processing power for higher resolution video can be a challenging issue for both hardware-based and software-based implementations. For example, an UHD frame may have a resolution of 3840×2160, which corresponds to 8,294,440 pixels per picture frame. If the video is captured at 60 frames per second, the UHD will generate nearly half billion pixels per second. For a color video source at YUV444 color format, there will be nearly 1.5 billion samples to process in each second. The data amount associated with the UHD video is enormous and poses a great challenge to real-time video decoder.

In order to fulfill the computational power requirement for high-definition, ultra-high resolution and/or more sophisticated coding standards, high speed processor and/or multiple processors have been used to perform real-time video decoding. For example, in the personal computer (PC) and consumer electronics environments, a multi-core Central Processing Unit (CPU) maybe used to decode video bitstream. The multi-core system may be in a form of embedded system for cost saving and convenience. In a conventional multi-core decoder system, a control unit often configures the multiple cores (i.e., multiple video decoder kernels) to perform frame-level parallel video decoding. In order to coordinate memory access by the multiple video decoder kernels, a memory access control unit may be used between the multiple cores and the shared memory among the multiple cores.

FIG. 1A illustrates a block diagram of a general dual-core video decoder system for frame-level parallel video decoding. The dual-core video decoder system 100A includes a control unit 110A, decoder core 0 (120A-0), decoder core 1 (120A-1) and memory access control unit 130A. Control unit 110A may be configured to designate decoder core 0 (120A-0) to decode one frame and designate decoder core 1 (120A-1) to decode another frame in parallel. Since each decoder core has to access reference data stored in a storage device such as memory, memory access control unit 130A is connected to memory and is used to manage memory access by the two decoder cores. The decoder cores may be configured to decode a bitstream corresponding to one or more selected video coding formats, such as MPEG-2, H.264/AVC and the new high efficiency video coding (HEVC) coding standards.

FIG. 1B illustrates a block diagram of a general quad-core video decoder system for frame-level parallel video decoding. The quad-core video decoder system 100B includes a control unit 110B, decoder core 0 (120B-0) through decoder core 3 (120B-3) and memory access control unit 130B. Control unit 110B may be configured to designate decoder core 0 (120B-0) through decoder core 3 (120B-3) to decode different frames in parallel. Memory access control unit 130B is connected to memory and is used to manage memory access by the four decoder cores.

While any compressed video format can be used for the HD or UHD contents, it is more likely to use newer compression standards such as H.264/AVC or HEVC due to their higher compression efficiency. FIG. 2A illustrates an exemplary system block diagram for video decoder 200A to support HEVC video standard. High-Efficiency Video Coding (HEVC) is a new international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block. A CU may begin with a largest CU (LCU), which is also referred as coded tree unit (CTU) in HEVC and each CU can be recursively split into four smaller CUs until the predefined minimum size is reached. Once the splitting of CU hierarchical tree is done, each CU is further split into one or more prediction units (PUs) according to prediction type and PU partition. Each CU or the residual of each CU is divided into a tree of transform units (TUs) to apply two-dimensional (2D) transforms.

In FIG. 2A, the input video bitstream is first processed by variable length decoder (VLD) 210 to perform variable-length decoding and syntax parsing. The parsed syntax may correspond to Inter/Intra residue signal (the upper output path from VLD 210) or motion information (the lower output path from VLD 210). The residue signal usually is transform coded. Accordingly, the coded residue signal is processed by inverse scan (IS) block 212, inverse quantization (IQ) block 214 and inverse transform (IT) block 216. The output from inverse transform (IT) block 216 corresponds to reconstructed residue signal. The reconstructed residue signal is added using an adder block 218 to Intra prediction from Intra prediction block 224 for an Intra-coded block or added to Inter prediction from motion compensation block 222 for an Inter-coded block. Inter/Intra selection block 226 selects Intra prediction or Inter prediction for reconstructing the video signal depending on whether the block is Inter or Intra coded. For motion compensation, the process will access one or more reference blocks stored in decoded picture buffer 230 and motion vector information determined by motion vector (MV) calculation block 220. In order to improve visual quality, in-loop filter 228 is used to process reconstructed video before it is stored in the decoded picture buffer 230. The in-loop filter includes deblocking filter (DF) and sample adaptive offset (SAO) in HEVC. The in-loop filter may use different filters for other coding standards. In FIG. 2A, all the functional blocks except for the decoder picture buffer (230) can be implemented by the decoder cores. In typical implementation, external memory such as DRAM (dynamic random access memory) is used for the decoder picture buffer (230).

For variable length decoder (VLD), due to its characteristics, it may be implemented separately instead of using the video decoder cores. In this case, a memory may be used to buffer the output from the VLD. FIG. 2B illustrates an example of video decoder kernel 200B excluding the VLD. Memory 240 is used to buffer the output from VLD 210B.

For Inter-frame level parallel decoding, due to data dependency, the mapping between to-be-decoded frames and multiple decoder kernels has to be done carefully to maximize performance. FIG. 3 illustrates an example of six pictures (i.e., I, P, P, B, B and B) in decoding order. These six pictures may correspond to I(1), P(2), B(3), B(4), B(5) and P(6) in display order, where the number in parenthesis represents the picture in display order. Picture I(1) is Intra coded by itself without any data dependency on any other picture. Picture P(2) is uni-directional predictive using reconstructed I(1) picture as a reference picture. When I(1) and P(2) are assigned to decoder kernel 0 and decoder kernel 1 respectively for parallel decoding (310), there will be data dependency issue. Similarly, when P(6) and B(3) are assigned to decoder kernel 0 and decoder kernel 1 respectively for parallel decoding in the second stage (320), the data dependency issue arises again. The last to-be-decoded pictures B(4) and B(5) are assigned to decoder kernel 0 and decoder kernel 1 respectively for parallel decoding in the third stage (330). Since both P(2) and P(6) are available at this time, there will be no data dependency issue for decoding B(4) and B(5) in parallel.

Due to the high computational requirements to support real-time decoding for HD or UHD video, multi-core decoders have been used to improve the decoding speed. One potential advantage of Inter-frame parallel decoding is the bandwidth efficiency due to common reference data. However, due to data dependency, the bandwidth efficiency may be degraded. Therefore, it is desirable to develop method and system that can resolve the data dependency issue so as to improve bandwidth efficiency.

### SUMMARY

A multi-core decoder system and an associated method use a decoding progress synchronizer to reduce bandwidth consumption for decoding a video bitstream is disclosed. In one embodiment of the present invention, the multi-core decoder system includes a shared reference data buffer coupled to the multiple decoder cores and an external memory. The shared reference data buffer stores reference data received from the external memory and provides the reference data the multiple decoder cores for decoding video data. The multi-core decoder system also includes one or more decoding progress synchronizers coupled to the multiple decoder cores to detect decoding-progress information associated with the multiple decoder cores or status information of the shared reference data buffer, and to control decoding progress for the multiple decoder cores.

The multi-core decoder system can use the decoding progress synchronizers to cause the decoding progress the multiple decoder cores to stall, speed up or slow down according to the decoding-progress information or the status information of the shared reference data buffer such as causing a sub-module state machine for one or more of the multiple decoder cores to stall, causing clock for one or more of the multiple decoder cores to stall or change, changing memory access priority for one or more of the multiple decoder cores, causing memory access to stall, or a combination of them. The decoding progress synchronizers may detect the decoding-progress information associated with the multiple decoder cores based on information related to location or index of currently decoded macroblock (MB), coding unit (CU), largest CU (LCU), or super block (SB) associated with the multiple decoder cores. For example, if difference between two locations or indices of currently decoded macroblocks or coding units associated with two decoder cores exceeds a threshold, the decoding progress synchronizers will cause a leading decoder core of the two decoder cores to stall or slow down, or cause a lagging decoder core of the two decoder cores to speed up. The decoding progress synchronizers may detect the status information of the shared reference data buffer based on whether any reference data accessed by one decoder core is about to be deleted or whether reference data reuse rate by one decoder core is decreasing or under a threshold.

The decoding progress synchronizers can be embedded in one or more decoder cores as integrated parts of the decoder cores. The multi-core decoder system may use only one decoding progress synchronizer and the decoding progress synchronizer is embedded in one decoder core as a master to detect the decoding-progress information associated with one or more of the multiple decoder cores, and to control the decoding progress for one or more of the multiple decoder cores. Alternatively, each decoder core may comprise one embedded decoding progress synchronizer to control the decoding progress for one respective decoder core, and embedded decoding progress synchronizers associated with the multiple decoder cores are configured for peer-to-peer operation.

In another embodiment, the multi-core decoder system may comprise a shared reference data buffer and a delay first-in-first-out (FIFO) block coupled to the multiple decoder cores, the shared reference data buffer and the external memory, wherein the delay FIFO block stores current reference data used by one decoder coder for later use by at least one another decoder core. The delay FIFO block can be implemented based on type 1 cache (L1 cache), type 2 cache (L2 cache), or other cache-like architecture. The multiple decoder cores, the shared reference data buffer and the delay FIFO block can be integrated on a same substrate of integrated circuits. The multi-core decoder system may further comprise one or more selector blocks, to select shared reference data buffer input from either the delay FIFO block or the external memory, or select reference data input for each decoder core from either the shared reference data buffer or the delay FIFO block.

In order to reduce bandwidth consumption, a leading decoder core can receive first reference data directly from the external memory instead of the shared reference data buffer, and the first reference data is also stored in the delay FIFO block. The address or location information associated with the first reference data can also be stored in the delay FIFO block. Therefore, when a lagging decoder core requires the first reference data and the first reference data is still stored in the delay FIFO block, the first reference data can be read into the shared reference data buffer and the lagging decoder core can read the first reference data from the shared reference data buffer.

In yet another embodiment, the multi-core decoder system uses a shared output buffer coupled to the multiple decoder cores and an external memory to reduce bandwidth consumption. The shared output buffer stores reconstructed data from a first decoder core and provides the reconstructed data to a second decoder core as reference data for decoding video data before storing the reconstructed data in the external memory. The reconstructed data can be organized into one or more windows and stored in the shared output buffer. The windows may have a common size corresponding to one single data word, one macroblock (MB), one sub-block, one coding unit (CU) or one largest coding unit (LCU). An oldest window of the reconstructed data can be flushed when the shared output buffer is full.

The multi-core decoder system may further include a window detector coupled to the multiple decoder cores, the shared output buffer and the external memory. The window detector determines whether the reconstructed data required by the second decoder core is in the shared output buffer. If the reference data required by the second decoder core is in the shared output buffer, the window detector may cause the reference data required by the second decoder core provided to the second decoder core from the shared output buffer. If the reference data required by the second decoder core is not in the shared output buffer, the window detector may cause the reference data required by the second decoder core provided to the second decoder core from the external memory.

The multi-core decoder system may further comprise a multiplexer coupled between the multiple decoder cores and the shared output buffer to select the reconstructed data from one of the multiple decoder cores to store in the shared output buffer. The multi-core decoder system may also further comprise a de-multiplexer coupled between the multiple decoder cores and the window detector to provide the reference data to one of the multiple decoder cores from either the shared output buffer or the external memory.

In another embodiment of this invention, a method for video decoding using multiple decoder cores in a decoder system is disclosed. The method comprises: the multiple decoder cores is arranged for decoding two or more frames from a video bitstream using inter-frame level parallel decoding; reference data stored in a shared reference data buffer is provided to the multiple decoder cores for decoding said two or more frames; and decoding progress for one or more of the multiple decoder cores is controlled to reduce memory access bandwidth associated with the shared reference data buffer according to decoding-progress information related to one or more of the multiple decoder cores or status information of the shared reference data buffer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A illustrates an exemplary decoder system with dual decoder cores for parallel decoding.

FIG. 1B illustrates an exemplary decoder system with quad decoder cores for parallel decoding.

FIG. 2A illustrates an exemplary decoder system block diagram based on the HEVC (High Efficiency Video Coding) standard.

FIG. 2B illustrates another exemplary decoder system block diagram based on the HEVC (High Efficiency Video Coding) standard, where the VLD is excluded from the decoder kernel.

FIG. 3 illustrates an example of assigning two frames to two decoder cores.

FIG. 4 illustrates an example of decoder system architecture 400 using on-chip memory for reference data buffer.

FIG. 5 illustrates an example of multiple decoder core system with shared reference buffer and Delay FIFO according to an embodiment of the present invention.

FIG. 6A illustrates decoding progress for leading decoder core A.

FIG. 6B illustrates decoding progress for lagging decoder core B.

FIG. 7 illustrates an example of incorporating a Decoding Progress Synchronizer into a parallel decoder system with a shared reference buffer.

FIG. 8 illustrates an example of a parallel decoder system with two decoder cores, a Decoding Progress Synchronizer and Delay FIFO according to an embodiment of the present invention.

FIG. 9A illustrates an example of incorporating the Decoding Progress Synchronizer into decoder core A in a master-slave arrangement.

FIG. 9B illustrates another example of incorporating the Decoding Progress Synchronizers into both decoder core A and decoder core B respectively in a peer-to-peer arrangement.

FIG. 10 illustrates an example of system architecture to enable one decoder core to access the reconstructed data from another decoder core according to an embodiment of the present invention, where an on-chip memory is used between two decoder cores.

FIG. 11 illustrates another perspective of on-chip memory arrangement for shared output buffer to store the reconstructed data from one decoder core for use by another decoder core.

FIG. 12 illustrates another example of on-chip memory arrangement for shared output buffer to store the reconstructed data from one decoder core for use by another decoder core, where the reconstructed data is organized into fixed size windows.

FIG. 13 illustrates an example of a parallel decoder system using a shared output buffer with a window detector to reduce bandwidth consumption.

FIG. 14 illustrates another example of a multi-core parallel decoder system using a shared output buffer with a window detector, where multiplexer and de-multiplexer are used to allow multiple decoder cores to share the shared output buffer and the window detector.

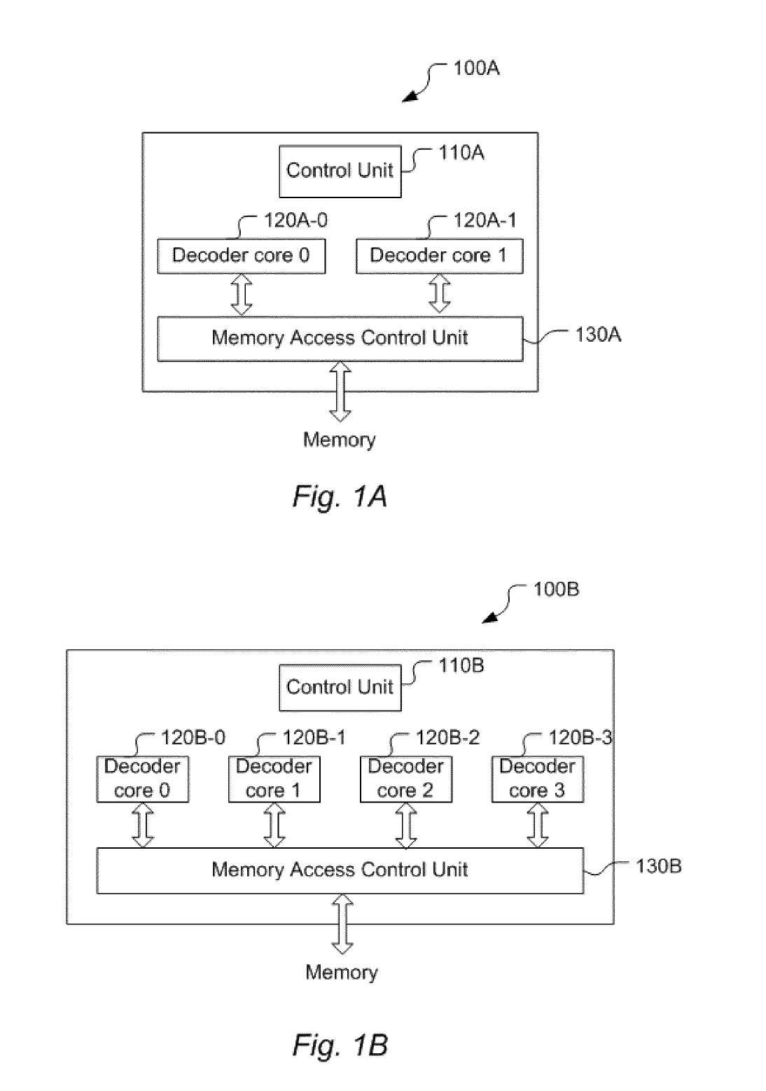

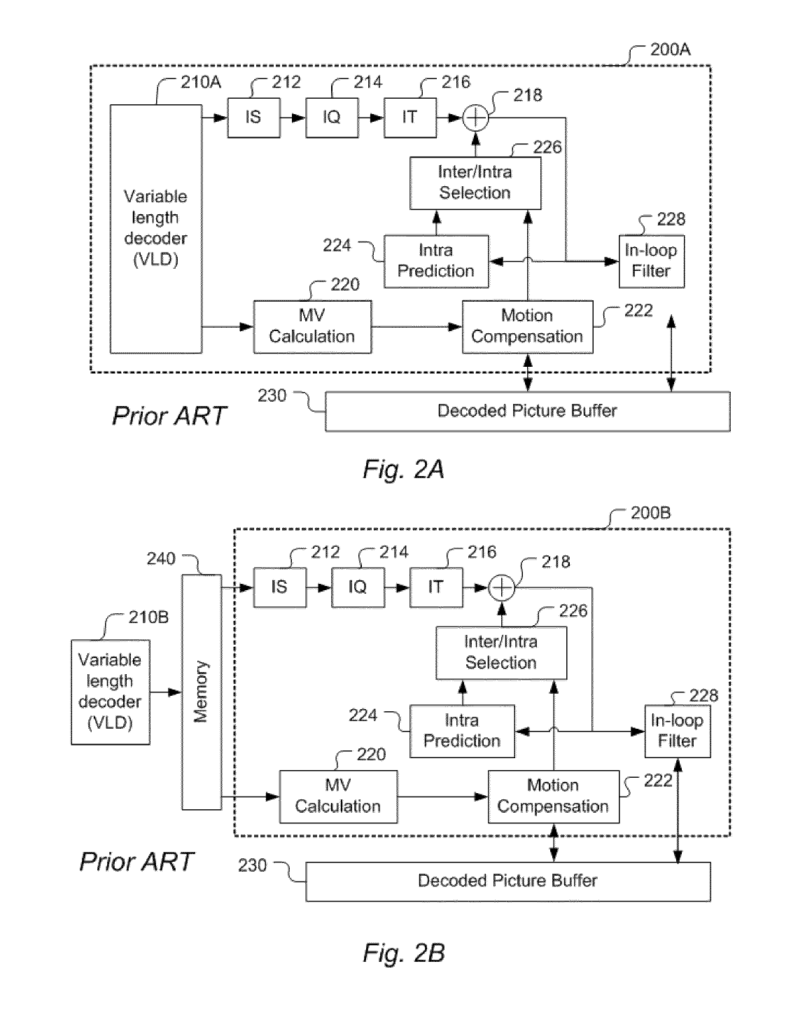

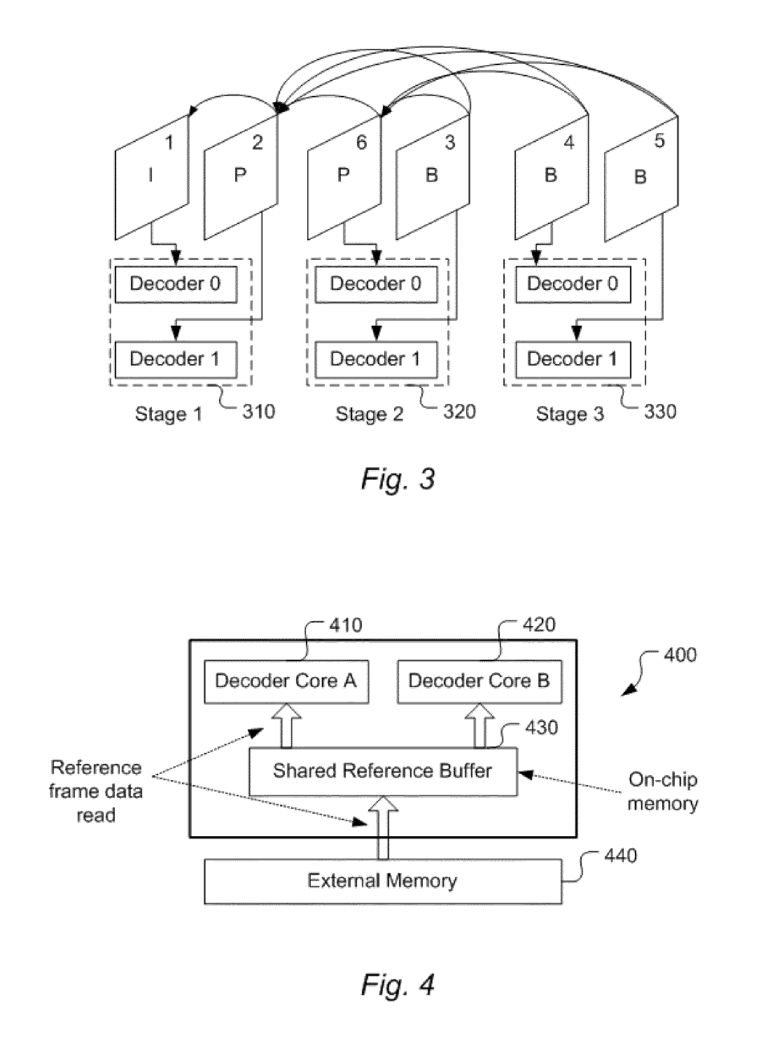

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention discloses multi-core decoder systems that can reduce memory bandwidth consumption. According to one aspect of the present invention, the candidates of video frames are chosen and assigned to Inter-frame level parallel decoding to reduce memory bandwidth consumption if the two frames refer to some overlapped reference data, or a video frame is assigned to a kernel that refers to another frame on another kernel. In these cases, there is chance to share the reference frame data access between the kernels and to reduce external memory bandwidth consumption. According to another aspect of the present invention, a Decoding Progress Synchronization (DPS) method and architecture are disclosed for multiple decoder kernel systems to reduce memory bandwidth consumption by maximizing data reuse. Furthermore, a reconstructed data reuse method and architecture are disclosed to reduce bandwidth consumption.

For motion-compensation coded video, the decoder needs to access reference data to generate Inter prediction data for motion-compensated reconstruction. Since previously reconstructed pictures may be stored in decoded picture buffer, which may be implemented using external memory, the access to the decoded picture buffer is relatively slow. Also, it will consume system bandwidth, which is an important system resource. Therefore, reference data buffer based on on-chip memory is often used to improve bandwidth efficiency. FIG. 4 illustrates an example of decoder system architecture 400 using an on-chip memory for reference data buffer. The decoder system in FIG. 4 includes two decoder cores (410, 420) and a shared reference buffer (430). The reference data is read into the shared reference buffer (430) first and the data in the shared reference buffer (430) maybe reused multiple times by the two decoder cores to reduce bandwidth consumption. For example, the decoder cores may be assigned to decode two consecutive B-pictures between two P-pictures for Inter-frame level parallel decoding. It is highly likely that the decoding process for the two B-pictures needs to access the same reference data associated with the two reference P-pictures. If the needed reference data is in the shared reference buffer (i.e., a “hit”), the needed reference data is reused without the need to access from the external memory. If the needed reference data is not in the shared reference buffer (i.e., a “miss”), the needed reference data will have to be read from the external memory. The shared reference buffer is much smaller than the external memory. However, the shared reference buffer is often implemented in different architecture from the external memory for high speed data access. For example, the shared reference buffer may be implemented using type 1 cache (L1 cache), type 2 cache (L2 cache) or cache-like architecture while the external memory is often based on DRAM (dynamic random access memory) technology.

While the shared reference buffer can help to improve bandwidth efficiency, the full benefit may not be realized in practice due to various reasons. For example, the decoding process may progress differently for two parallel decoded frames on two decoder cores. In the event that one decoder core is leading the other by far, the two decoder cores may be accessing very different reference data areas. Therefore, the lagging decoder core may need to reload data from the external memory (i.e. , a “miss”). The shared reference memory is often implemented using high speed memory to improve performance. Due to the high cost associated with the high speed memory, the size of the shared reference memory is limited. In order to further improve the bandwidth efficiency for a system with shared reference buffer, embodiments of the present invention introduces a Delay FIFO (first-in first-out) block coupled to the external memory, the shared reference buffer and the decoder cores. Delay FIFO may be implemented in different data structure/architecture from the shared reference buffer to achieve higher capacity and lower cost, such as a dedicated on-chip SRAM (Static Random Access Memory), or L1/L2 cache.

FIG. 5 illustrates an example of multiple decoder core system 500 with shared reference buffer and Delay FIFO block according to embodiments of the present invention.

In the example of FIG. 5, two decoder cores (510, 520) are used. In addition to the shared reference buffer (530), a Delay FIFO (540) is also used. The external memory is considered as external to multiple decoder core system 500. For the leading decoder core that leads progress of decoding ahead of the lagging decoder core, the reference frame data is read from external memory to the core directly without storing it in the shared reference buffer. However, the reference frame data read from external memory is also stored in the Delay FIFO along with the address or location information of the reference frame data. In this case, a multiplexor (512 or 522) is used to select reference data directly from the external memory into the decoder core. The system will monitor the location information of the oldest entry of the Delay FIFO. When the decoding progress of the lagging decoder core catches up to the location of the oldest entry, the oldest entry is de-queued and the reference data is transferred into shared reference buffer so that the lagging decoder core can access the reference data from the shared reference buffer without the need of accessling the external memory. In this case, multiplexor 532 is set to select input from Delay FIFO 540. The system is FIG. 5 can also be configured to support the conventional shared reference buffer without the Delay FIFO. In this case, multiplexors 512 and 522 are set to select input from the shared reference buffer and multiplexor 532 is set to select input from external memory 550.

The use of Delay FIFO should help to improve bandwidth efficiency. For example, if decoder core A is the leading core that is processing macroblock (MB) located at block location (x, y) with (x, y)=(10, 2). Decoder core B is the lagging core that is processing MB at (x, y)=(3, 2). In this case, reference data for decoder core A will be placed into the Delay FIFO since decoder core B is processing an area that is far from block location (10, 2) being processed by decoder core A. It is less likely that decoder core B would need the same reference data as decoder core A. However, when decoder core B advances the progress to or close to block location (10, 2), the reference data in Delay FIFO can be placed into the shared reference buffer. In this case, the probability that decoder core B can use the data in the shared reference buffer is greatly increased. Accordingly, the bandwidth efficiency is improved due to the use of Delay FIFO.

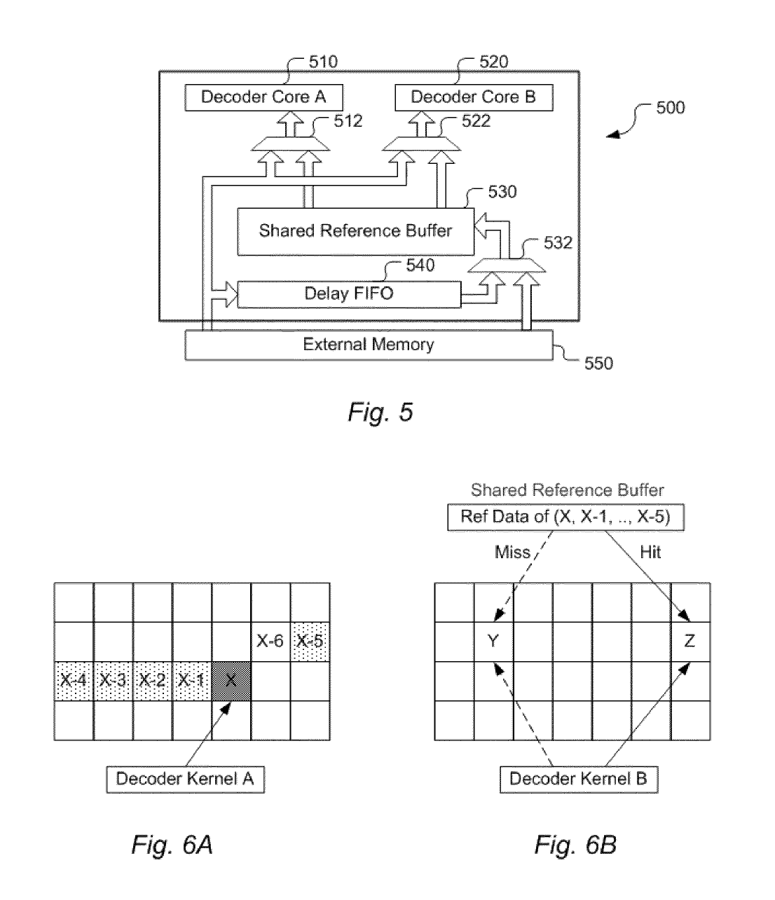

According to another aspect of the present invention, the system uses a Decoding Progress Synchronization (DPS) method to improve the bandwidth efficiency. As mentioned earlier, the shared reference buffer is relatively small. If the decoder cores are processing image areas that are far apart from each other, it is less likely that the decoding process for the decoder cores can share the same reference data. Accordingly, another embodiment of the present invention manages to synchronize the decoding progress among the multiple decoder cores. For example, two decoder cores (core A and core B) are used for Inter-frame level parallel decoding of two frames and the shared reference buffer can store reference data for five blocks. If decoder core A is processing block X shown in FIG. 6A and decoder core B is processing block Y shown in FIG. 6B, it is less likely that decoder core B can reuse reference data in the shared reference buffer. This is because that only reference data for blocks (X-1) through (X-5) will be stored in the shared reference buffer, and blocks X and Y are too far apart. On the other hand, if decoder core A is processing block X shown in FIG. 6A and decoder core B is processing block Z shown in FIG. 6B, it is more likely that decoder core B can reuse reference data in the shared reference buffer since blocks X and Z are closer. Accordingly, the system will check the progress of the two cores and ensure that the difference between two currently processed blocks is within a limit. For example, if the decoder core A is processing a block with block index, block_index_A and the decoder core B is processing a block with block index, block_index_B, the system will limit |block_index_A−block_index_B|<Th, where Th is a threshold between 1 and the total number of blocks in a frame.

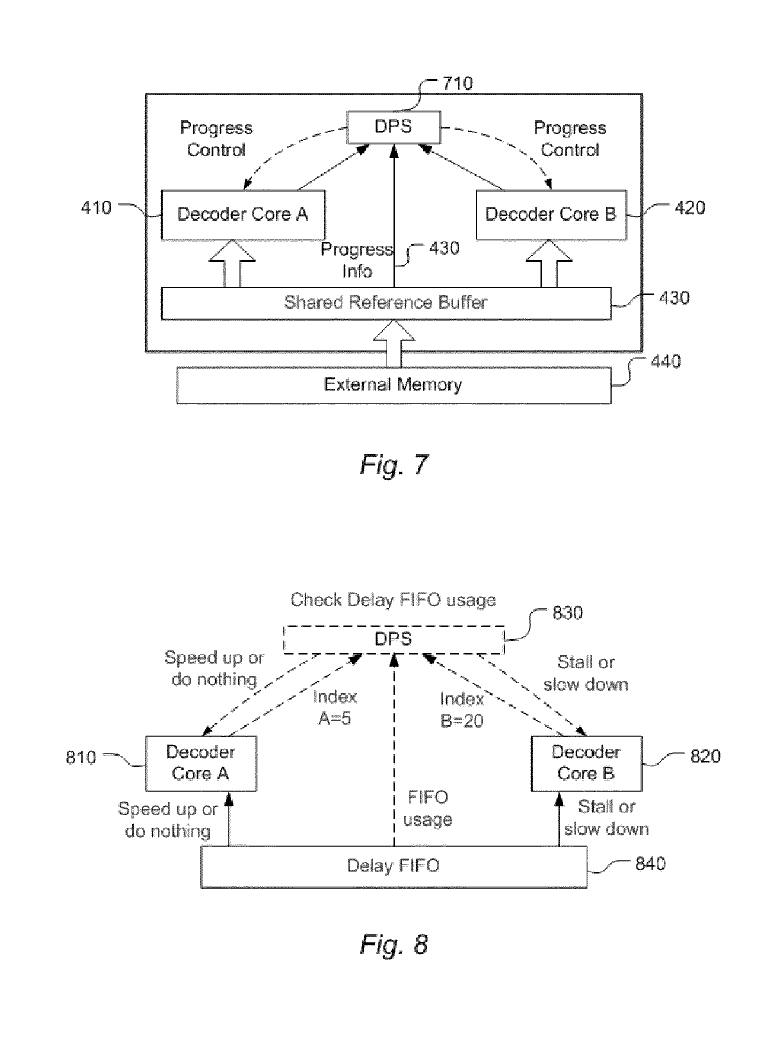

In order to keep the difference between two currently processed blocks within a limit, the system will control the progress of each decoder core. If the decoding progress of a decoder kernel executed on one core is too far away from the other core, the effectiveness of the shared reference buffer will be reduced. In this case, more access to the external memory becomes more likely. Therefore, the system slow down or pause the leading core or speed up the lagging core to shorten the difference within the limit so as to improve the efficiency (i.e., higher hit rate) of the shared reference buffer. FIG. 7 illustrates an example of incorporating a Decoding Progress Synchronizer into a parallel decoder system with a shared reference buffer. As shown in FIG. 7, the Decoding Progress Synchronizer (710) is coupled to decoder core A (410) and decoder core B (420) to monitor the progress of decoding and to control the progress accordingly. As shown in FIG. 7, the Decoding Progress Synchronizer (710) may also detect information related to the shared reference buffer (430) and apply control to the decoder cores accordingly.

In order to monitor the decoding progress of decoder kernels, the system may use the Decoding Progress Synchronizer (710) to detect their progress according to the (x, y)-location or index of a currently decoded MB, coding unit (CU), largest CU (LCU), or super block (SB). Partial location or index information may be used. For example, the system may use only the x-location or y-location to determine the progress. The system may also detect their progress according to the address of memory access. According to the detected progress, the system may use the Decoding Progress Synchronizer (710) to stall or speed up/slow down each decoder kernel respectively. The control may be achieved by controlling kernel/sub-module state-machine (e.g. pause), clock of each kernel (e.g. pause, speed up/slow down), memory access priority of each kernel, other factors affecting decoding progress or decoding speed, or any combination, or causing memory access to stall.

For example, the system may use the Decoding Progress Synchronizer (710) to detect the decoding progress of each kernel and calculate the difference in the decoding progress. The decoding progress may correspond to index (index_A or index_B) of the currently processed image unit. The image unit may correspond to a MB or a LCU. If |index_A−index_B|≧Th, the difference in decoding progress needs to be reduced, where Th represents a threshold. In order to reduce the difference in decoding progress, the system may slow down or pause for the decoding progress of the leading core that has a larger index until the difference in decoding progress is with the threshold. Alternatively, the system may speed up for the decoding progress of the lagging decoder core that has a smaller index until the difference in decoding progress is within the threshold.

In another example, the system may check the status of the shared reference buffer as shown in FIG. 7. If the status indicates that the reference data accessed by any kernel will be deleted soon or the data reuse rate is decreasing or under a threshold, the system will control the decoding progress of each kernel.

In another embodiment, the Decoding Progress Synchronizer can be used along with the delay FIFO disclosed above. FIG. 8 illustrates an example of a parallel decoder system with two decoder cores (810, 820), Decoding Progress Synchronizer 830 and Delay FIFO 840. The system may check whether the Delay FIFO is full or almost full, and then control the decoding progress of each kernel. When the Delay FIFO is full or almost full, it is an indication that the decoding progress of a decoder kernel executed on one core is too far away from the other core, since delay FIFO may check the location to decide whether to consume data entry and output to the shared reference buffer or not. On the other word, the location checking maybe in DPS itself or in delay FIFO or other module. In this case, the control should be applied to reduce the difference in progress between the two decoder cores. The Decoding Progress Synchronizer can be a separate module in the decoder core. Alternatively, the Decoding Progress Synchronizer can be incorporated into the Delay FIFO as an integrated Delay FIFO/Decoding Progress Synchronizer.

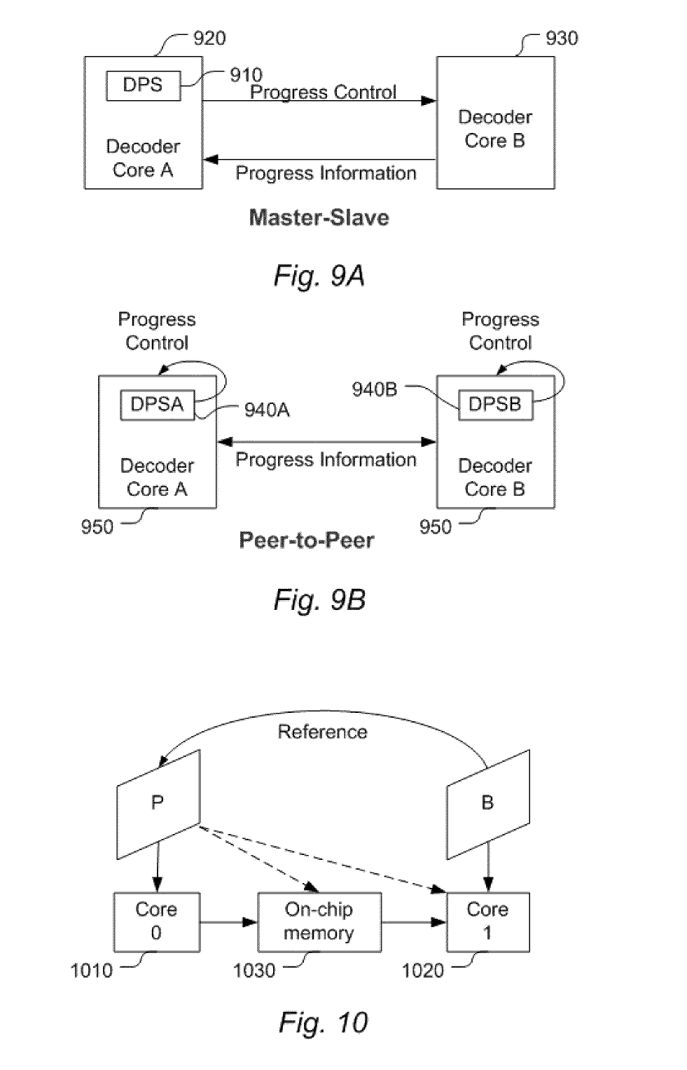

In yet another embodiment of the present invention, the Decoding Progress Synchronizer is incorporated into the one or more decoder cores as an integrated part of the decoder core(s). For example, FIG. 9A illustrates an example of incorporating the Decoding Progress Synchronizer (910) into decoder core A (920) in a master-slave arrangement. The two decoder cores are coupled to each other so that the Decoding Progress Synchronizer (910) in decoder core A (920) can detect decoding progress from and provide progress control to decoder core B (930). In this case, decoder core A is considered as a master for decoding progress synchronization. FIG. 9B illustrates another example of incorporating the Decoding Progress Synchronizers (940A, 940B) into both decoder core A (950) and decoder core B (960) respectively in a peer-to-peer arrangement. The two decoder cores are coupled to each other so that the two decoder cores can obtain progress information from each other. Based on the progress information, the Decoding Progress Synchronizers (940A, 940B) will control the progress of respective decoder cores.

In yet another embodiment of the present invention, the system enables motion compensation in one decoder core to access to the reconstructed data from another decoder core for Inter-frame level parallel decoding of two frames with data dependency. FIG. 10 illustrates an example of system architecture to enable one decoder core to access the reconstructed data from another decoder core, where an on-chip memory (1030) is used between two decoder cores (1010, 1020). The reconstructed data from one decoder core is stored in the on-chip memory to be reused by the other core so as to reduce bandwidth consumption. In this example, a P-picture is assigned to decoder core 0 and a B-picture is assigned to decoder core 1, where the B-picture uses the P-picture as a reference picture. Therefore, the P-picture or a part of the P-picture has to be reconstructed before the B-picture decoding can start. In a conventional approach, the reconstructed P-picture data would be written to decoded reference picture buffer and decoder core 1 would have to access the reference data from the decoded reference picture buffer. As mentioned before, the decoded reference picture buffer usually is implemented using external memory. Accordingly, the on-chip memory (1030) is used to buffer some reconstructed data of the P-picture for use by decoder core 1 in order to process the B-picture. Detailed reconstructed data reuse via the on-chip memory is described as follows.

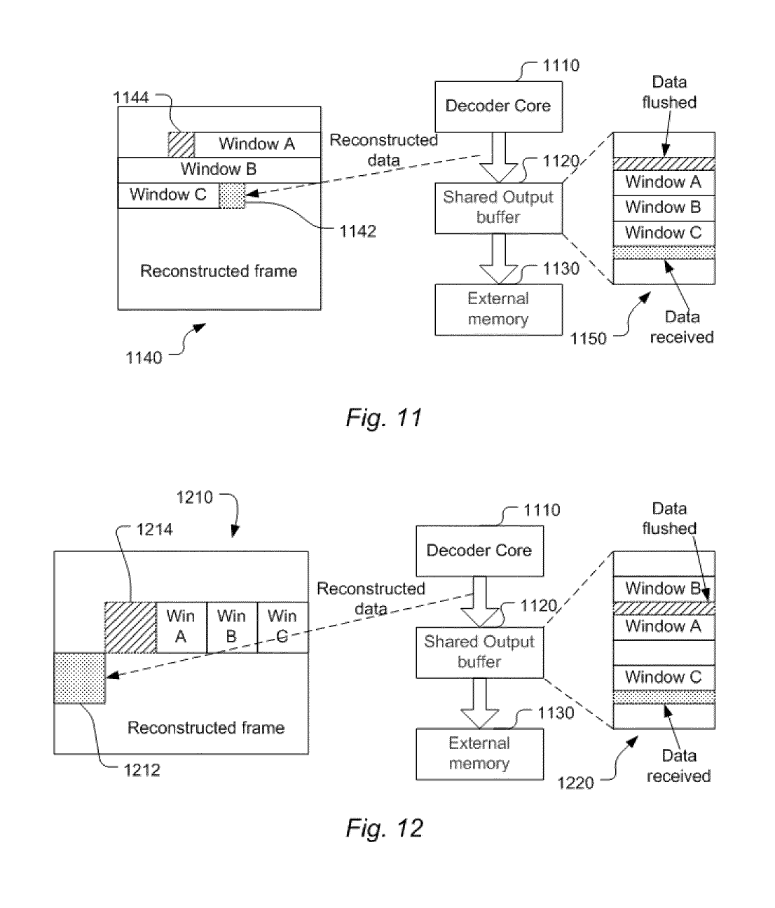

The on-chip memory (1030) in FIG. 10 can be used as a shared output buffer for decoder core 0 (1010) that is responsible for decoding the P-picture. FIG. 11 illustrates another perspective of on-chip memory arrangement. The reconstructed data from decoder core (1110), that is expected to be referenced by the other decoder core, is stored in shared output buffer 1120 (i.e., the on-chip memory in FIG. 10) instead of being stored in external memory 1130 directly. After the reconstructed data is reused by the other decoder core or when the reconstructed data needs to be flushed out, the reconstructed data stored in shared output buffer 1120 is written into the decoded picture buffer in external memory 1130. The reconstructed data stored in the shared output buffer can be organized with a given size smaller than a whole frame. When new reconstructed data was received, some previous received data may have to be flushed. Furthermore, the range of data stored in the shared output buffer can be denoted by one or more windows, which is between two external memory address or between two point (x, y) and (x′, y′). For example, block 1140 represents a reconstructed frame, where data location 1142 corresponds to data just received and data location 1144 corresponds to data flushed. The data area between data location 1144 and data location 1142 are stored in the shared output buffer is shown in block 1150. Also shown in FIG. 11, data area between data location 1144 and data location 1142 consists of three windows (i.e., window A, window B and window C). The data location 1144 and data location 1142 can be designated by external memory addresses (x, y) and (x′, y′). The range of each window may be updated when data is received or flushed. Each window can be stored in the on-chip memory with continuous space or with separated spaces.

While the windows in FIG. 11 have different sizes, the windows may also have a common size. The common size may correspond to a single data word, a macroblock (MB), a sub-block or a larger block. FIG. 12 illustrates an example of windows using a common size. Block 1210 represents a reconstructed frame, where data location 1212 corresponds to data just received and data location 1214 corresponds to data flushed. Block 1220 illustrates an example of storing fixed-size windows in the shared output buffer in non-consecutive spaces. Each window may be mapped to a starting address with lower part of address corresponding to a power-of-2 value. Therefore, the window matching can be achieved efficiently by comparing address sub-pattern.

According to yet another aspect of the present invention, a window detector is used to determine whether the required reference data is in the shared output buffer and to access the required reference data from the shared output buffer of the external memory accordingly. When a core accesses the reference frame data, the window detector will provide window matching process by comparing the required reference frame data address or (x, y) location with each window in the shared output buffer. If the address/location of the required reference data is between the starting and ending addresses/locations of a window, it indicates that the reference data is in this window. If window matching is successful (i.e., the required reference frame data in the window), the system calculates the offset for the required data in the on-chip memory and read the reference data starting from the offset location. When the window matching fails, the system reads the reference data from the external memory if the required addresses or locations have already been flushed, this can be known by the system using address or location comparison. If the reference data is not ready yet for both shared output buffer and external memory, the system may stall the access.

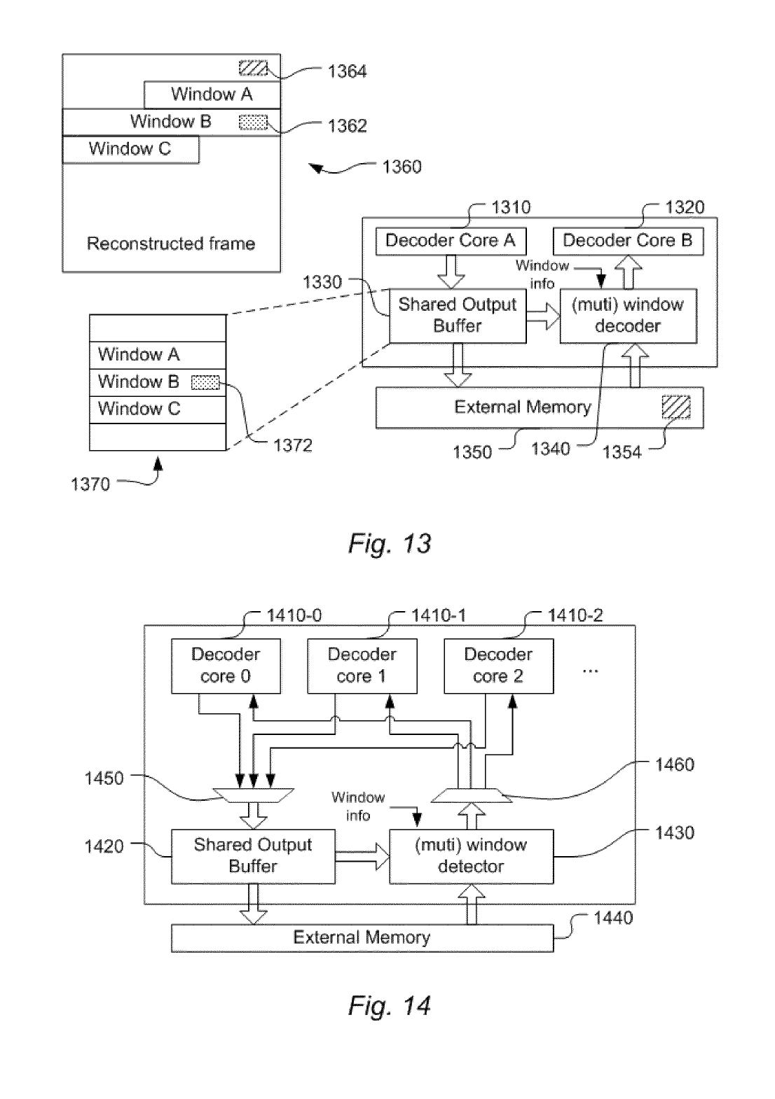

FIG. 13 illustrates an example of a parallel decoder system using a shared output buffer with a window detector (1340). The system comprises two decoder cores (1310, 1320), a shared output buffer (1330) and the window detector (1340). Both the shared output buffer (1330) and the window detector (1340) are coupled to the external memory (1350). Block 1360 illustrates the locations of windows A, B and C within the reconstructed frame, where the reconstructed data associated with windows A, B and C is stored in the shared output buffer for possible reuse by decoder core B (1320). For the reconstructed frame, the reconstructed data prior to window A is stored in the decoded reference picture buffer in the external memory (1350). For example, the reference data 1362 before window A is stored in area 1354 of the external memory. Block 1370 illustrates an example of status of the shared output buffer, where reconstructed data associated with windows A, B and C is stored in the shared output buffer. If decoder core B (1320) requires accessing the reconstructed data (1362) in window B, the window detector (1340) will detect the situation and read the corresponding reconstructed data (1372) from the shared output buffer. In the case that decoder core B (1320) requires accessing the reconstructed data (1364) already stored in the external buffer (1350), the window detector (1340) will detect the situation and read the corresponding reconstructed data (1354) from the external memory (1350).

While FIG. 13 illustrates an example of a parallel decoder system using a shared output buffer with a window detector, the embodiment can be extended to parallel decoder system with more than two decoder cores. FIG. 14 illustrates an example of a multi-core parallel decoder system using a shared output buffer with a window detector. The system comprises multiple decoder cores (1410-0, 1410-1, 1410-2, etc.), a shared output buffer (1420) and a window detector (1430). Both the shared output buffer (1420) and the window detector (1430) are coupled to the external memory (1440). Multiplexer 1450 is used to select one of the decoder cores as input to the shared output buffer (1420) and de-multiplexer 1430 is used to route the data from window detector 1430 to one of the decoder cores. Each window in the shared output buffer can include picture ID so that the shared output buffer can be shared among the multiple cores. Also, window detector 1430 can serve multiple cores so that two or more decoder cores can reference the reconstructed data in the shared output buffer.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

The parallel decoder system may also be implemented using program codes stored in a readable media. The software code may be configured using software formats such as Java, C++, XML (extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention. The software code may be executed on different types of devices, such as laptop or desktop computers, hand held devices with processors or processing logic, and also possibly computer servers or other devices that utilize the invention. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-core decoder system, comprising:
multiple decoder cores;
a shared reference data buffer coupled to the multiple decoder cores and an external memory, wherein the shared reference data buffer stores reference data received from the external memory and provides the reference data to the multiple decoder cores for decoding video data; and
one or more decoding progress synchronizers coupled to one or more of the multiple decoder cores to detect decoding-progress information associated with one or more of the multiple decoder cores or status information of the shared reference data buffer, and to control decoding progress for one or more of the multiple decoder cores.

2. The multi-core decoder system of claim 1, wherein said one or more decoding progress synchronizers are embedded in one or more decoder cores as integrated parts of said one or more decoder cores.

3. The multi-core decoder system of claim 2, wherein the multi-core decoder system uses only one decoding progress synchronizer and the decoding progress synchronizer is embedded in one decoder core as a master to detect the decoding-progress information associated with one or more of the multiple decoder cores, and to control the decoding progress for one or more of the multiple decoder cores.

4. The multi-core decoder system of claim 2, wherein each decoder core comprises one embedded decoding progress synchronizer to control the decoding progress for one respective decoder core, and embedded decoding progress synchronizers associated with the multiple decoder cores are configured for peer-to-peer operation.

5. The multi-core decoder system of claim 1, further comprising a delay first-in-first-out (FIFO) block coupled to one or more decoder cores, the shared reference data buffer and the external memory, wherein the delay FIFO block stores current reference data used by one decoder coder for later use by another decoder core.

6. The multi-core decoder system of claim 5, said one or more decoding progress synchronizers are embedded in one or more decoder cores as integrated parts of said one or more decoder cores or the multi-core decoder system uses only one decoding progress synchronizer embedded in the delay FIFO block.

7. The multi-core decoder system of claim 1, wherein the shared reference data buffer is implemented based on type 1 cache (L1 cache), type 2 cache (L2 cache), or other cache-like architecture.

8. A multi-core decoder system, comprising:
multiple decoder cores;
a shared reference data buffer coupled to the multiple decoder cores and an external memory, wherein the shared reference data buffer stores reference data received from the external memory and provides the reference data to the multiple decoder cores for decoding video data; and
a delay first-in-first-out (FIFO) block coupled to the multiple decoder cores, the shared reference data buffer and the external memory, wherein the delay FIFO block stores current reference data used by one decoder coder for later use by at least one another decoder core.

9. The multi-core decoder system of claim 8, wherein the delay FIFO block is implemented based on type 1 cache (L1 cache), type 2 cache (L2 cache), or dedicated on-chip SRAM (Static Random Access Memory).

10. The multi-core decoder system of claim 8, wherein the shared reference data buffer is implemented based on type 1 cache (L1 cache), type 2 cache (L2 cache), or other cache-like architecture.

11. The multi-core decoder system of claim 10, wherein the multiple decoder cores, the shared reference data buffer and the delay FIFO block are integrated on a same substrate of integrated circuits.

12. The multi-core decoder system of claim 8, wherein a leading decoder core receives first reference data from the external memory instead of the shared reference data buffer, and the first reference data is also stored in the delay FIFO block.

13. The multi-core decoder system of claim 12, wherein address or location information associated with the first reference data is also stored in the delay FIFO block.

14. The multi-core decoder system of claim 12, wherein, when a lagging decoder core requires the first reference data and the first reference data is still stored in the delay FIFO block, the first reference data is read into the shared reference data buffer and the lagging decoder core reads the first reference data from the shared reference data buffer.

15. The multi-core decoder system of claim 8, further comprising one or more selector blocks, wherein said one or more selector blocks select shared reference data buffer input from either the delay FIFO block or the external memory, or select reference data input for each decoder core from either the shared reference data buffer or the delay FIFO block.

16. A multi-core decoder system, comprising:
multiple decoder cores; and
a shared output buffer coupled to the multiple decoder cores and an external memory, wherein the shared output buffer stores reconstructed data from a first decoder core and provides the reconstructed data to a second decoder core as reference data for decoding video data before storing the reconstructed data in the external memory.

17. The multi-core decoder system of claim 16, wherein the reconstructed data is organized into one or more windows and stored in the shared output buffer, and wherein each window size is smaller than a whole frame.

18. The multi-core decoder system of claim 17, wherein said one or more windows have a common size, wherein the common size corresponds to one single data word, one macroblock (MB), one sub-block, one coding unit (CU) or one largest coding unit (LCU).

19. The multi-core decoder system of claim 17, wherein an oldest window of the reconstructed data is flushed when the shared output buffer is full.

20. The multi-core decoder system of claim 16, further comprising a window detector coupled to the multiple decoder cores, the shared output buffer and the external memory, wherein the window detector determines whether the reconstructed data required by the second decoder core is in the shared output buffer.

21. The multi-core decoder system of claim 20, wherein the window detector causes the reference data required by the second decoder core provided to the second decoder core from the shared output buffer if the reference data required by the second decoder core is in the shared output buffer.

22. The multi-core decoder system of claim 20, wherein the window detector causes the reference data required by the second decoder core provided to the second decoder core from the external memory if the reference data required by the second decoder core is not in the shared output buffer.

23. The multi-core decoder system of claim 20, wherein the reconstructed data stored in the shared output buffer is organized into one or more windows with a window address for each window, and wherein the window detector determines whether the reconstructed data required by the second decoder core as the reference data is in the shared output buffer based on the window address for each window and reference data address.

24. The multi-core decoder system of claim 23, wherein the window detector determines that the reconstructed data required by the second decoder core as the reference data is in the shared output buffer if the reference data address is greater than or equal to a starting window address and smaller than or equal to an ending window address for one window.

25. The multi-core decoder system of claim 20, further comprising a multiplexer coupled between the multiple decoder cores and the shared output buffer to select the reconstructed data from one of the multiple decoder cores to store in the shared output buffer.

26. The multi-core decoder system of claim 20, further comprising a de-multiplexer coupled between the multiple decoder cores and the window detector to provide the reference data to one of the multiple decoder cores from either the shared output buffer or the external memory.

27. The multi-core decoder system of claim 16, wherein the shared output buffer is implemented based on type 1 cache (L1 cache), type 2 cache (L2 cache), or other cache-like architecture.

28. A method for video decoding using multiple decoder cores in a decoder system, comprising:
arranging the multiple decoder cores for decoding two or more frames from a video bitstream using inter-frame level parallel decoding;
providing reference data stored in a shared reference data buffer to the multiple decoder cores for decoding said two or more frames; and
controlling decoding progress for one or more of the multiple decoder cores to reduce memory access bandwidth associated with the shared reference data buffer according to decoding-progress information related to one or more of the multiple decoder cores or status information of the shared reference data buffer.

29. The method of claim 28, wherein said controlling decoding progress for one or more of the multiple decoder cores causes the decoding progress for one or more of the multiple decoder cores to stall, speed up or slow down according to the decoding-progress information or the status information of the shared reference data buffer.

30. The method of claim 28, wherein said controlling decoding progress for one or more of the multiple decoder cores causes the decoding progress for one or more of the multiple decoder cores to stall, speed up or slow down by causing a sub-module state machine for one or more of the multiple decoder cores to stall, causing clock for one or more of the multiple decoder cores to stall or change, changing memory access priority for one or more of the multiple decoder cores, causing memory access to stall, or a combination thereof.

31. The method of claim 28, wherein the decoding-progress information associated with said one or more of the multiple decoder cores is detected based on information related to location or index of currently decoded macroblock (MB), coding unit (CU), largest CU (LCU), or super block (SB) associated with the multiple decoder cores.

32. The method of claim 31, wherein if difference between two locations or indices of currently decoded macroblocks or coding units associated with two decoder cores exceeds a threshold, said one or more decoding progress synchronizers cause a leading decoder core of the two decoder cores to stall or slow down, or cause a lagging decoder core of the two decoder cores to speed up.

33. The method of claim 28, wherein the status information of the shared reference data buffer is detected based on whether any reference data accessed by one decoder core is about to be deleted or whether reference data reuse rate by one decoder core is decreasing or under a threshold.
